(19) United States
(12) Patent Application Publication
(10) Pub. No.: US 2010/0240782 A1
(43) Pub. Date: Sep. 23, 2010

(54) PROCESS FOR PREPARING STYRENE-BASED (CO)POLYMERS

(75) Inventors: Andreas Herman Hogt, Enschede (NL); Bart Fischer, Leusden (NL)

Correspondence Address: KENYON & KENYON LLP, ONE BROADWAY, NEW YORK, NY, 10004, US

(73) Assignee: AKZO NOBEL N.V., ARNHEM (NL)

(21) Appl. No.: 12/740,793

(22) PCT Filed: Nov. 17, 2008
(86) PCT No.: PCT/EP2008/065657

§ 371 Date: Apr. 30, 2010

Related U.S. Application Data
(60) Provisional application No. 60/992,212, filed on Dec. 4, 2007.

(30) Foreign Application Priority Data
Nov. 20, 2007 (EP) 07121123.9

(51) Int. Cl. C08J 9/16; C08F 212/08; C08L 25/08

(52) U.S. Cl. 521/56; 526/347; 524/578

(57) ABSTRACT

A process for preparing a styrene-based (co)polymer comprising the steps of: a) preparing a monomer composition comprising styrene monomer and optionally one or more co-monomers and b) polymerising the monomer composition in the presence of an initiator mixture containing (i) 55-95 wt % of at least one polyfunctional initiator having a 1-hour half-life temperature in the range of 70-110° C. and (ii) 5-45 wt % of at least one monofunctional initiator having a 1-hour half-life temperature in the range of 70-110° C., so as to form the styrene-based (co)polymer.

The invention relates to process for preparing styrene-based (co)polymers.

An example of such a process that is generally applied is the suspension polymerisation of styrene to produce expandable polystyrene (EPS). This process is usually carried out with a rising temperature profile and polymerisation initiators with different half-life temperatures. The actual polymerisation is carried out in the first stage of the process, which is generally performed at a temperature in the range of 70-110° C., preferably 80-90° C., using a polymerisation initiator with a 1-hour half-life temperature within this range (e.g. dibenzoyl peroxide). The second stage serves to remove any residual styrene monomer and is conducted at a higher temperature using a peroxide with a higher 1-hour half-life temperature.

Such a process is, for instance, disclosed in U.S. Pat. No. 5,900,872.

During the polymerisation of styrene, flame retardants or chain transfer agents are generally present. These compounds, however, tend to act as molecular weight (MW) reducing additives. That is: they cause the resulting polystyrene to have a lower MW, which is generally undesired.

It has now been found that this reduction in MW can be counteracted by using a specific combination of initiators in the first stage of polymerisation.

The invention therefore relates to a process for preparing a styrene-based (co)polymer comprising the steps of:
a) preparing a monomer composition comprising styrene monomer and optionally one or more co-monomers and
b) polymerising the monomer composition in the presence of an initiator mixture comprising (i) 55-95 wt % of at least one polyfunctional initiator having a 1-hour half-life temperature in the range of 70-110° C. and (ii) 5-45 wt % of at least one monofunctional initiator having a 1-hour half-life temperature in the range of 70-110° C., so as to form the styrene-based (co)polymer.

The process of the invention allows for a correction of the MW of the (co)polymer when MW-reducing additives, such as a flame retardant, are used in steps a) and/or b) of the process.

The process according to the invention requires the use of an initiator mixture containing at least one polyfunctional initiator and at least one monofunctional initiator. The term “monofunctional initiator” refers to an initiator having only one group capable of forming a radical. The term “polyfunctional initiator” refers to an initiator having two or more groups capable of forming a radical. Polyfunctional initiators include bifunctional initiators, which contain two groups capable of forming a radical, and also trifunctional initiators, which contain three groups capable of forming a radical. Initiator mixtures having a plurality of polyfunctional initiators having a different number of radical-inducing groups are also contemplated.

In one embodiment, the initiator mixture comprises at least one monofunctional initiator and at least one bifunctional initiator. The viscosity of the initiator mixture is generally lower than the viscosity of the polyfunctional initiator as such. This lower viscosity is advantageous on account of easy processing and for allowing more accurate dosing to the reaction mixture.

The mono- and the polyfunctional initiators both have a 1-hour half-life temperature in the range of 70-110° C., preferably 80-100° C. This 1-hour half-life temperature is defined as the temperature at which, in 1-hour, the original initiator content is reduced by 50% and is determined by differential scanning calorimetry-thermal activity monitoring (DSC-TAM) of a dilute solution of the initiator in monochlorobenzene.

The monofunctional and polyfunctional initiators can be selected from organic peroxides and azo-containing initiators, as long as they have a 1-hour half-life temperature in the range of 70-110° C. Preferred initiators are organic peroxides.

Examples of suitable monofunctional initiators are dibenzoyl peroxide, 1,1,3,3-tetramethylbutyl peroxy-2-ethyl hexanoate, t-amyl peroxy-2-ethyl hexanoate, t-butyl peroxy-2-ethyl hexanoate, and t-butyl peroxyisobutyrate. The most preferred monofunctional initiator is t-butyl peroxy-2-ethylhexanoate.

Examples of suitable polyfunctional initiators are peresters prepared from polyhydroperoxides or polyacid chlorides, preferably from dihydroperoxides or diacid chlorides. Examples of such peresters are:
peresters of 2,5-dimethyl-2,5-di(hydroperoxy) hexane, such as 2,5-dimethyl-2,5-di(2-ethylhexanoylperoxy) hexane, 2,5-dimethyl-2,5-di(2-ethylbutanoylperoxy) hexane, or 2,5-dimethyl-2,5-di(pivaloylperoxy) hexane,
peresters of di(hydroperoxyisopropyl)benzene, such as di(2-ethyl-hexanoylperoxyisopropyl)benzene, di(2-ethylbutanoylperoxyisopropyl)-benzene, or di(pivaloylperoxyisopropyl)benzene, and
peresters of 1,4-cyclohexyldicarbonic acid, such as di(t-butylperoxy) 1,4-cyclohexyldicarboxylate, di(2-ethylhexanoylperoxy) 1,4-cyclohexyl-dicarboxylate, or di(2-ethylbutanoylperoxy) 1,4-cyclohexyldicarboxylate.

A preferred polyfunctional initiator is 2,5-dimethyl-2,5-di(2-ethylhexanoylperoxy) hexane.

Said initiators are present during the first stage of the polymerisation. It is possible, if so desired, to have a further initiator with a higher 1-hour half-life temperature present in order to remove any residual styrene monomer during the second stage of polymerisation. Examples of such further initiators are tert-butylperoxy benzoate, tert-butylperoxy 2-ethylhexyl carbonate, tert-amylperoxy 2-ethylhexyl carbonate, and dicumyl peroxide.

The process according to the invention involves the polymerisation of styrene monomer or of styrene-containing monomer mixtures. Preferably, these styrene-comprising monomer mixtures comprise at least 50% by weight (wt %) of styrene, based on the weight of all monomer. Co-monomers that can be used are of the conventional type, and are generally ethylenically unsaturated monomers and preferably selected from the group consisting of maleic anhydride, maleic acid, fumaric acid, vinyl acetate, ethylene, propylene, acrylonitrile, butadiene, and (meth)acrylates and including ethylenically unsaturated polymers, such as polybutadiene and styrene butadiene rubber. Although it is less preferred, also vinylidene chloride can be copolymerised. More preferably, at least 80 wt % of the monomers being polymerised is styrene, while the most preferred process is one wherein essentially all monomer is styrene.

The polymerisation process can be conducted as a mass process wherein the reaction mixture is predominantly monomer, or as a more preferred suspension process wherein the reaction mixture typically is a suspension of monomer in water, or as an emulsion or micro-emulsion process wherein the monomer typically is emulsified in water.

The process according to the invention is especially suited for use in suspension processes. In these processes the usual additives may be used. For example, for suspensions in water, one or more of the usual additives such as a surfactant, a chain transfer agent, a protective colloid, an anti-fouling agent, a pH-buffer, flame retardants, flame retardant synergists, etc., may be present. Blowing agents can be added at the start of or during the polymerisation process. Because of the presence of styrene monomer and blowing agents such processes are at least partially carried out in a pressurised reactor. The combined weight of the additives preferably is at most 20 wt %, based on the combined weight of all monomers.

In one embodiment of the invention, the process is a batchwise suspension polymerisation process involving the use of a blowing agent, for making expandable polystyrene (EPS).

The initiators can be added to the polymerisation reaction mixture of step b) (i) as a mixture, (ii) simultaneously but separately—e.g. at different locations in the reactor, or (iii) separately at different points in time. If added separately, the initiators can be added at once in random order or in portions one after the other or in any other sequential order. The initiators can be added continuously to the reaction mixture at the polymerisation temperature, as described in WO 2004/089999. In a preferred embodiment, the initiators are added as an initiator mixture, and even more preferably as a liquid initiator mixture, on account of the processing and dosing advantages described before.

The total amount of monofunctional and polyfunctional initiators with a 1-hour half-life in the range of 70-110° C. to be used in the process according to the invention is within the range conventionally used in the first stage of styrene polymerisation processes. Typically, it is preferred to use at least 0.01 wt %, more preferably at least 0.05 wt %, and most preferably at least 0.1 wt % of initiator, and preferably at most 5 wt %, more preferably at most 3 wt %, and most preferably at most 1 wt % of initiator, based on the weight of the monomers to be polymerised

In a further embodiment of the present invention, the monomer composition further comprises a molecular weight-reducing additive. By the term “molecular weight-reducing additive” is meant an additive which causes the resulting (co)polymer to have a lower MW compared to a (co)polymer obtained with the same process except that the additive is absent. Examples of such molecular weight-reducing additives include chain transfer agents such as mercaptans and flame retardants, in particular halide-containing flame retardants. Halide-containing flame retardants are commonly used in styrene-containing (co)polymers. Suitable examples include bromine-containing organic flame retardants such as hexabromo cyclododecane (HBCD), 2,3,4,5,6,-pentabromo-1-bromomethyl benzene (PBBMB), and those disclosed in WO 2006/013554, WO 2006/071213, and WO 2006/071214, which are incorporated herein by reference. The process of the invention is particularly suitably used in combination with 2,3,4,5,6,-pentabromo-1-bromomethyl benzene as flame retardant, as this flame retardant causes a higher reduction in M_{w} of the resulting styrene-based (co)polymer than hexabromo cyclododecane, said reduction being counteracted by the process of the present invention.

The molecular weight-reducing additives are added in amounts conventionally used in styrene-containing polymerisation processes. Typically, it is preferred to use at least 0.01 wt %, more preferably at least 0.05 wt %, and most preferably at least 0.1 wt %, and preferably at most 20 wt %, more preferably at most 15 wt %, and most preferably at most 10 wt % of the molecular weight-reducing additive, based on the weight of the monomers to be polymerised.

The invention further pertains to the styrene-based (co)polymer obtained with the process of the invention. This (co)polymer differs structurally from conventional styrene-containing (co)polymers, as the initiator is built into the backbone of the (co)polymer. The use of a mixture of initiators having different radical-inducing groups, i.e. a monofunctional and a polyfunctional initiator, causes the resulting (co)polymer to contain parts of both initiators.

### EXAMPLES

### Example 1

Into a 1-litre stainless steel reactor (Buchi 8315.3 E2843) equipped with a baffle, a three-bladed impeller, a pressure transducer, and a nitrogen purge, were charged 1.25 g of tricalcium phosphate. Subsequently, 260 g of an aqueous solution containing 20 mg Nacconol 90F (sodium benzene dodecyl sulphonate) and 50 mg Gohsenol C500 (partially hydrolysed polyvinyl acetate) were added to the reactor and stirred for approximately 5 minutes. A solution of the first stage initiator, 0.46 meq./100 g total styrene of Trigonox® 117 (tert-butylperoxy 2-ethylhexyl carbonate ex Akzo Nobel) and 0.2 wt % Perkadox® BC (dicumyl peroxide ex Akzo Nobel), based on total weight of styrene, dissolved in 200 g styrene, and a solution of flame retardant in 50 g styrene were charged into the reactor. It is noted that Trigonox® 117 served as a second stage initiator, generally causing initiation at higher temperatures, and Perkadox® BC is a flame retardant synergist.

The temperature was raised to 90° C. at a rate of 1.56° C./min and kept at 90° C. for 4.25 hours. Subsequently, the temperature was increased to 130° C. at a rate of 0.67° C./min, at which temperature the reactor was maintained for 3 hours. About 15 minutes before the end of the first stage, 20 g pentane were added from a bomb by pressurising the reactor with nitrogen (5 bar).

After being cooled to room temperature (overnight), the reaction mixture was acidified with HCl (10%) to pH=1.5 and stirred for about 1 hour. The product was filtered and the EPS beads obtained were washed with water to pH>6 and with an aqueous solution of 25 ppm Armostat 400 (antistatic), respectively. Finally, the EPS was dried at room temperature for about 24 hours.

The above procedure was carried out with the following styrene solutions containing flame retardants as set out in Table 1. The amounts used in Table 1 are in wt %, based on the total weight of styrene, and meg./100 g styrene, which refers to milliequivalents or millimoles of (mono)peroxy group equivalents per 100 g of styrene.

The amounts of bromine in the flame retardant in Comparative Examples A and B were set at the same molar level. The same holds for Comparative Examples C and D and Example 1.

It is further noted that the peroxides listed in Table 1 serve as first stage initiators.

TABLE 1

| | Flame | Amount | | Amount |
|---|---|---|---|---|
| Example | retardant | (wt %) | Peroxide | (meq./100 g styrene) |
| A | HBCD¹ | 0.5 | Px L³ | 1 |
| B | PBBMB² | 0.44 | Px L | 1 |
| C | HBCD | 0.56 | Px L | 1 |
| D | PBBMB | 0.5 | Tx 141⁴/Tx 21⁵ | 1 |
| | | | (50/50)⁶ | |
| 1 | PBBMB | 0.5 | Tx 141/Tx 21 | 1 |
| | | | (65/35)⁶ | |

¹hexabromo cyclodecane;
²2,3,4,5,6-pentabromo-1-bromomethyl benzene;
³Perkadox ® L: a dibenzoyl peroxide ex Akzo Nobel;
⁴Trigonox ® 141: 2,5-dimethyl-2,5-di(2-ethylhexanoylperoxy) hexane ex Akzo Nobel;
⁵Trigonox ® 21: tert-butyl peroxy-2-ethylhexanoate ex Akzo Nobel
⁶weight ratio

The particle size distribution and the molecular weights, i.e. the weight average molecular weight (M_{w}) and the number average molecular weight (Mₙ), of the resulting polystyrene beads were analysed. The particle size (distribution) is determined by sieving according to ASTM D1921-63 (method A). A curve-fit program is used to calculate the average particle size (APS) and spread.

The M_{w}, Mₙ, and the polydispersity ratio D (D=M_{w}/Mₙ) of the polymers obtained are determined by size exclusion chromatography in tetrahydrofuran solvent, using polystyrene standards with defined molecular weights as reference. The results are listed in Table 2 below.

TABLE 2

| Example | M_{w} | Mₙ | D | APS |
|---|---|---|---|---|
| A | 191,000 | 89,000 | 2.1 | 879 |
| B | 162,000 | 79,000 | 2.1 | 717 |
| C | 185,000 | 92,500 | 2.0 | |
| D | 173,000 | 78,000 | 2.2 | |
| 1 | 185,000 | 88,000 | 2.1 | |

The use of PBBMB caused a reduction in M₁ and Mₙ as compared to the use of HBCD as a flame retardant (see Comparative Examples A and B). When using a mixture of a monofunctional peroxide (Trigonox 21) and a bifunctional peroxide (Trigonox 141) as first stage initiators in combination with PBBMB (Comparative Example D and Example 1), M_{w}, Mₙ, and D improve. However, only if the ratio of bifunctional to monofunctional initiator is higher than 50/50 is a polystyrene product obtained with values for M_{w}, Mₙ, and D comparable to those of a polystyrene obtained using a mono-functional peroxide and HBCD (Comparative Example C vs Example 1).

1. A process for preparing a styrene-based (co)polymer comprising the steps of:
a) preparing a monomer composition comprising styrene monomer and optionally one or more co-monomers and
b) polymerising the monomer composition in the presence of an initiator mixture comprising (i) 55-95 wt % of at least one polyfunctional initiator having a 1-hour half-life temperature in the range of 70-110° C. and (ii) 5-45 wt % of at least one monofunctional initiator having a 1-hour half-life temperature in the range of 70-110° C., so as to form the styrene-based (co)polymer.

2. The process according to claim 1 wherein the polymerisation is a suspension polymerisation reaction.

3. The process according to claim 1 wherein the polymer obtained is an expandable polystyrene.

4. The process according to claim 1 wherein the polymerisation is a mass polymerisation reaction.

5. The process according to claim 1 wherein the monomer composition further comprises a molecular weight-reducing additive.

6. The process according to claim 5 wherein the molecular weight-reducing additive is a flame retardant.

7. The process according to claim 6 wherein the flame retardant is a bromine-containing flame retardant.

8. The process according to claim 7 wherein the bromine-containing flame retardant is 2,3,4,5,6-pentabromo-1-bromomethyl benzene.

9. A styrene-based (co)polymer obtained by the process of claim 1.

10. The process according to claim 2 wherein the polymer obtained is an expandable polystyrene.

11. The process according to claim 2 wherein the monomer composition further comprises a molecular weight-reducing additive.

12. The process according to claim 3 wherein the monomer composition further comprises a molecular weight-reducing additive.

13. The process according to claim 4 wherein the monomer composition further comprises a molecular weight-reducing additive.

14. The process according to claim 10 wherein the monomer composition further comprises a molecular weight-reducing additive.

15. The process according to claim 11 wherein the molecular weight-reducing additive is a flame retardant.

16. The process according to claim 12 wherein the molecular weight-reducing additive is a flame retardant.

17. The process according to claim 13 wherein the molecular weight-reducing additive is a flame retardant.

18. The process according to claim 14 wherein the molecular weight-reducing additive is a flame retardant.

19. The process according to claim 15 wherein the flame retardant is a bromine-containing flame retardant.

20. The process according to claim 16 wherein the flame retardant is a bromine-containing flame retardant.

21. The process according to claim 17 wherein the flame retardant is a bromine-containing flame retardant.

22. The process according to claim 18 wherein the flame retardant is a bromine-containing flame retardant.

23. The process according to claim 19 wherein the bromine-containing flame retardant is 2,3,4,5,6-pentabromo-1-bromomethyl benzene.

24. The process according to claim 20 wherein the bromine-containing flame retardant is 2,3,4,5,6-pentabromo-1-bromomethyl benzene.

25. The process according to claim 21 wherein the bromine-containing flame retardant is 2,3,4,5,6-pentabromo-1-bromomethyl benzene.

26. The process according to claim 22 wherein the bromine-containing flame retardant is 2,3,4,5,6-pentabromo-1-bromomethyl benzene.

27. A styrene-based (co)polymer obtained by the process of claim 26.
